(19) United States
(12) Patent Application Publication
(10) Pub. No.: US 2025/0112695 A1
(43) Pub. Date: Apr. 3, 2025

(54) SYSTEMS AND METHODS FOR SERVICE TURN-UP OPTIMIZATION THROUGH QUALITY OF SERVICE FEEDBACK ON OPTICAL LINE SYSTEMS

(71) Applicant: infinera Corp., San Jose, CA (US)

(72) Inventors: Jonathan Michael Buset, San Jose, CA (US); Thomas Gerard, Campbell, CA (US); Nisar Ahmed, Bellevue, WA (US); Sanjeev Ramachandran, Manipal (IN); Ashok Kunjidhapatham, Karnataka (IN)

(21) Appl. No.: 18/897,935

(22) Filed: Sep. 26, 2024

Related U.S. Application Data
(60) Provisional application No. 63/541,658, filed on Sep. 29, 2023.

(51) Int. Cl. H04B 10/079; H04B 10/294

(52) U.S. Cl. CPC H04B 10/0795; H04B 10/2942

(57) ABSTRACT

Optical networks, network elements, and methods of use are described herein, including a network element comprising a processor; and a non-transitory computer readable memory storing instructions that, when executed by the processor, cause the processor to: receive, from a headend network element, instructions to collect a QoS baseline measurement indicative of performance of optical carrier(s) on a transmission line, collect the QoS baseline measurement; collect a QoS current measurement of the QoS data, after a first spectral loading operation is performed on the transmission line segment by the headend network element; determine that a numerical difference between the QoS current measurement and the QoS baseline measurement is outside of a predetermined threshold; and send instructions to the headend network element to abort a second spectral loading operation for the transmission line segment and to execute an AGC cycle to adjust amplifier operating conditions.

### CROSS-REFERENCE TO RELATED APPLICATIONS

This application claims priority to the provisional patent application identified by U.S. Ser. No. 63/541,658, titled “Service Turn-up Optimization Through Quality of Service Feedback on Optical Line Systems”, filed Sep. 29, 2023, the entire content of which is hereby expressly incorporated herein by reference.

### BACKGROUND

Optical networking is a communication means that utilizes signals encoded in light to transmit information (e.g., data) as an optical signal in various types of telecommunications networks. Optical networking may be used in relatively short-range networking applications such as in a local area network (LAN) or in long-range networking applications spanning countries, continents, and oceans. Generally, optical networks utilize optical amplifiers, a light source such as lasers or LEDs, and wavelength division multiplexing to enable high-bandwidth communication.

Optical networks are a critical component of the global Internet backbone. This infrastructure acts as the underlay, providing the plumbing for all other communications to take place (e.g., access, metro, and long-haul). In the traditional 7-layer OSI model, Optical networks constitute the Layer 1 functions, providing digital transmission of bit streams transparently across varying distances over a chosen physical media (in this case, optical). Optical networks also encompass an entire class of devices (which are referred to as Layer 0), which purely deal with optical photonic transmission and wavelength division multiplexing (WDM). This includes amplification, (re-)generation, and optical add/drop multiplexing (OADM). The most widely adopted Layer 1/Layer 0 transport networking technologies today, referred to as Optical Transport Networks (OTN), are based on ITU-T standards. Both these classes of networks are connection-oriented and circuit-switched in nature.

Dense Wavelength Division Multiplexing (DWDM) is an optical transmission technology that uses a single optical fiber line to simultaneously transport multiple optical services of different wavelengths. The different wavelengths are conventionally separated into several frequency bands, each frequency band being used as an independent channel to transport optical services of particular wavelengths. The Conventional Band (C-band) typically includes signals with wavelengths ranging from 1530 nm to 1565 nm, is the frequency band in which optical services experience the lowest amount of loss, and is the band most commonly used in DWDM. The Long-wavelength Band (L-band), which typically includes signals with wavelengths ranging from 1565 nm to 1625 nm, is the frequency band in which optical services experience the second lowest amount of loss, and is the frequency band often used when the C-band is insufficient to meet bandwidth requirements. Optical line systems that use both the C-band and the L-band are referred to as C+L or C/L optical line systems.

A persistent challenge in the field of optical networking is the detection and correction of channel tilt, a phenomenon in which optical channels of different wavelengths within an optical signal experience varying degrees of gain or loss as the optical signal travels through optical multiplex sections (OMSs). Tilt can significantly degrade signal quality and limit system performance. To address the issue of tilt, various tilt correction techniques have been developed. These techniques typically involve dynamically adjusting amplifier gains or employing specialized filters to achieve a flat frequency response across all optical channels.

Wideband optical transmission systems experience Stimulated Raman Scattering (SRS), a physical effect that occurs in conventional optical fiber which transfers power from high to low frequency signals. That is, power from optical carriers having shorter wavelengths is transferred to optical carriers having longer wavelengths during transmission. When signals are added or removed from the headend of a link, the change in SRS can cause significant transient power changes to other traffic-carrying signals in the link, which is potentially traffic-impacting. Loading (that is, adding or removing) optical carriers may cause existing optical carriers to suffer traffic loss if the power transient is large enough and the optical carrier does not have a sufficiently large design margin to overcome such impairments. Optical communication systems capable of transporting data on multiple bands—such as a C-band, an L-band, and an O-band—are inherently susceptible to transient changes in spectral shape caused by SRS because of their large bandwidth and high power requirements. As such, any loading changes may impact the spectral shape throughout the system due to loading-induced changes in the SRS tilt.

Optical communication systems provided with amplified spontaneous emission (ASE) idlers may mitigate some transient effects by maintaining the system near full spectral loading and making small perturbations by slowly swapping between ASE and optical signals during loading changes. However, ASE loading by itself does not inherently solve the problem of optimizing and prioritizing traffic to balance transients with operation timing.

To avoid these problems, a user must take care not to make too many changes to the loading of an optical link at once; however, this is operationally complex and difficult to judge without detailed system information and modelling. The safest approach is to change signals one at a time and run automated gain controls (AGC) throughout the link after every change; however, this is very time intensive and typically unnecessarily conservative.

Modern line systems may use a Loading Manager that accepts a full set of loading requests from the user and automates the process of batch-loading the signals using internal system information. An exemplary Loading Manager is described in U.S. Patent Publication No. 20230327762A1, entitled “Method of Transient Management in Optical Transmission Systems”, filed Apr. 7, 2023, and published Oct. 12, 2023, the entire contents of which are hereby incorporated herein. This relieves the operational burden from the user and aims to strike a desired balance between loading speed and SRS-induced optical impact. Simple Loading Managers may use static or fixed rule sets to simply service provisioning; however, these may significantly under-estimate or over-estimate the actual SRS-induced optical disturbance, either risking traffic impact or wasting time, respectively. More advanced feed-forward algorithms can combine static and dynamic system information to better estimate the impact of a given set of loading changes, improving loading execution speed where possible while reducing the risk to traffic. However, limitations to the implementational complexity of real-time models, as well as the risk of external disturbances to the link during loading, mean even the best feed-forward method risks under-estimating the SRS-induced optical impact to existing services.

Accordingly, there is a need for a systems and methods that can check and adjust operating conditions to improve overall system timing, allowing more loading operations to be serialized without executing a time-consuming automatic gain control (AGC) cycle, unless deemed necessary.

### SUMMARY OF THE INVENTION

Optical transport networks, network elements, and methods of use are disclosed herein, including an Optical Multiplexed Section (OMS)-level feedback mechanism within the channel activation/deactivation procedures and workflows in optical line systems. The invention enables the system to closely monitor service-level, and passband-level, quality of service (QoS) metrics during loading operations and execute an automatic gain control (AGC) cycle to adjust the amplifier operating conditions if one or more service-level metric thresholds are exceeded.

This feedback mechanism improves overall system timing performance, allowing more loading operations to be serialized without executing unnecessary time-consuming AGC cycles.

In some implementations, the problems of improving spectral loading execution speed where possible, while reducing the risk to traffic is solved by a network element, which may comprise: a processor; and a non-transitory computer readable memory storing instructions that, when executed by the processor, cause the processor to: receive, from a headend network element on a transmission line segment, instructions to collect a quality-of-service (QoS) baseline measurement of QoS data, wherein the QoS data is indicative of performance of an optical carrier on the transmission line segment; collect the QoS baseline measurement; collect a QoS current measurement of the QoS data, after a first spectral loading operation is performed on the transmission line segment by the headend network element; determine that a numerical difference between the QoS current measurement and the QoS baseline measurement is outside of a predetermined threshold; and send instructions to the headend network element to abort a second spectral loading operation for the transmission line segment and to execute an automatic gain control (AGC) cycle to adjust amplifier operating conditions.

In some implementations, the problems are solved by an optical network, comprising: a headend network element comprising a headend processor and a headend non-transitory computer readable memory; a tail-end network element comprising a tail-end processor and a tail-end non-transitory computer readable memory; and a transmission line segment connecting the headend network element and the tail-end network element; and wherein the tail-end non-transitory computer readable memory stores instructions that, when executed by the tail-end processor, cause the tail-end processor to: receive, from the headend network element through the transmission line segment, instructions to collect a quality-of-service (QoS) baseline measurement of QoS data, wherein the QoS data is indicative of performance of an optical carrier on the transmission line segment; collect the QoS baseline measurement; collect a QoS current measurement of the QoS data, after a first spectral loading operation is performed on the transmission line segment by the headend network element; determine that a numerical difference between the QoS current measurement and the QoS baseline measurement is outside of a predetermined threshold; and send instructions to the headend network element to abort a second spectral loading operation for the transmission line segment and to execute an automatic gain control (AGC) cycle to adjust amplifier operating conditions; wherein the headend non-transitory computer readable memory stores instructions that, when executed by the headend processor, cause the headend processor to: abort the second spectral loading operation for the transmission line segment; execute the AGC cycle to adjust the amplifier operating conditions; and perform a second spectral loading operation on the transmission line segment.

In some implementations, the problems are solved with an optical network, comprising: a headend network element comprising a headend processor and a headend non-transitory computer readable memory; a tail-end network element comprising a tail-end processor and a tail-end non-transitory computer readable memory; and a transmission line segment connecting the headend network element and the tail-end network element; and wherein the tail-end non-transitory computer readable memory stores instructions that, when executed by the tail-end processor, cause the tail-end processor to: receive, from the headend network element through the transmission line segment, instructions to collect a quality-of-service (QoS) baseline measurement of QoS data, wherein the QoS data is indicative of performance of an optical carrier on the transmission line segment; and collect the QoS baseline measurement; and collect a QoS current measurement of the QoS data, after a first spectral loading operation is performed on the transmission line segment by the headend network element; and send the QoS baseline measurement and the QoS current measurement to the headend network element; wherein the headend non-transitory computer readable memory stores instructions that, when executed by the headend processor, cause the headend processor to: receive the QoS baseline measurement and the QoS current measurement; determine that a numerical difference between the QoS current measurement and the QoS baseline measurement is outside of a predetermined threshold by comparing the QoS current measurement to the QoS baseline measurement; and abort the second spectral loading operation for the transmission line segment; execute the AGC cycle to adjust the amplifier operating conditions; and perform a second spectral loading operation on the transmission line segment.

Implementations of the above techniques include methods, apparatus, systems, and computer program products. One such computer program product is suitably embodied in a non-transitory machine-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of hardware forming a system having an exemplary optical network and a network administration device constructed in accordance with the present disclosure.

FIG. 2 is a diagrammatic view of an exemplary user device constructed in accordance with the present disclosure.

FIG. 3 is a diagrammatic view of an exemplary network administration device constructed in accordance with the present disclosure.

FIG. 4 is a diagrammatic view of an exemplary network element constructed in accordance with the present disclosure.

FIG. 5 is a diagram of an exemplary method for service loading assisted by QoS feedback, in accordance with the present disclosure.

FIG. 6 is a diagrammatic view of an exemplary portion of an optical signal for loading on the system of FIG. 1 in accordance with the present disclosure.

FIG. 7 is an exemplary workflow diagram in accordance with the present disclosure.

FIG. 8 is a diagrammatic representation of an exemplary C-band and L-Band optical spectrum at a headend network element in accordance with the present disclosure.

FIG. 9 is a diagrammatic representation of an exemplary C-band and L-Band optical spectrum at a tail-end network element based on the spectrum of FIG. 8 in accordance with the present disclosure.

FIG. 10 is a diagrammatic representation of an exemplary C-band and L-Band optical spectrum at a headend network element in accordance with the present disclosure.

FIG. 11 is a diagrammatic representation of an exemplary C-band and L-Band optical spectrum at a tail-end network element based on the spectrum of FIG. 10 in accordance with the present disclosure.

### DETAILED DESCRIPTION

The following detailed description refers to the accompanying drawings. The same reference numbers in different drawings may identify the same or similar elements.

Before explaining at least one implementation of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other implementations or of being practiced or carried out in various ways. Also, it is to be understood that the phraseology and terminology employed herein are for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one implementation”, “an implementation”, or “some implementations” means that a particular element, feature, structure, or characteristic described in connection with the implementation is included in at least one implementation and may be used in conjunction with other implementations. The appearances of the phrase “in one implementation” or “in some implementations” in various places in the specification are not necessarily all referring to the same implementation.

Further, the phrase “based on” is intended to mean “based, at least in part, on” unless explicitly stated otherwise.

Circuitry, as used herein, may be analog and/or digital components referred to herein as “blocks”, or one or more suitably programmed processors (e.g., microprocessors) and associated hardware and software, or hardwired logic. Also, “components” or “blocks” may perform one or more functions. The term “component” or “block” may include hardware, such as a processor (e.g., a microprocessor), a combination of hardware and software, and/or the like.

Software may include one or more processor-executable instructions that when executed by one or more components (e.g., a processor) cause the component to perform a specified function. It should be understood that the algorithms described herein may be stored on one or more non-transitory processor-readable mediums, such as a memory. Exemplary non-transitory memory may include random-access memory (RAM), a read-only memory (ROM), a flash memory, and/or a non-volatile memory such as, for example, a CD-ROM, a hard drive, a solid-state drive, a flash drive, a memory card, a DVD-ROM, a Blu-ray Disk, a disk, and an optical drive, combinations thereof, and/or the like. Such non-transitory processor-readable media may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

The generation of laser beams for use as optical data channel signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

As used herein, an “optical communication path” and/or an “optical route” may correspond to an optical path and/or an optical light path. For example, an optical communication path may specify a path along which light is carried between two or more network entities along an optical fiber link (e.g., an optical fiber).

As used herein, an optical link may be an optical fiber, an optical channel, an optical super-channel, a super-channel group, an optical carrier group, a set of spectral slices, an optical control channel (e.g., sometimes referred to herein as an optical supervisory channel or an “OSC”), an optical data channel (e.g., sometimes referred to herein as “BAND”), and/or any other optical signal transmission link.

The optical network has one or more band. A band is the complete optical spectrum carried on the optical fiber. Depending on the optical fiber used and the supported spectrum which can be carried over long distances with the current technology, relevant examples of the same are: C-Band/L-Band/Extended-C-Band. As used herein, the C-Band is a band of light having a wavelength between about 1530 nm and about 1565 nm. The L-Band is a band of light having a wavelength between about 1565 nm and about 1625 nm. Because the wavelength range of the C-Band includes wavelengths smaller than the wavelengths of the wavelength range of the L-Band, the wavelengths of the C-Band may be described as short, or a shorter, wavelengths relative to the L-Band. Similarly, because the wavelengths of the L-Band are larger than the wavelengths of the C-Band, the wavelengths of the L-Band may be described as long, or a longer, wavelengths relative to the C-Band. An optical link may be composed of spectral slices pertaining to C-Band and/or L-Band spectrum. C+L Band spectrum has about 9.6 THz worth of optical bandwidth (i.e., 4.8 THz×2).

In some implementations, an optical super-channel may include multiple channels multiplexed together using wavelength-division multiplexing in order to increase transmission capacity. Various quantities of channels may be combined into super-channels using various modulation formats to create different super-channel types having different characteristics. Additionally, or alternatively, a super-channel group may include multiple super-channels multiplexed together using wavelength-division multiplexing in order to increase transmission capacity.

Additionally, or alternatively, an optical link may be a set of spectral slices. As used herein, a spectral slice (a “slice”) may represent a spectrum of a particular size in a frequency band (e.g., 12.5 gigahertz (“GHz”), 6.25 GHz, 3.125 GHz, etc.). For example, a 4.8 terahertz (THz) frequency band may include 384 spectral slices, where each spectral slice may represent 12.5 GHz of the 4.8 THz spectrum. A slice may be the resolution at which the power levels can be measured by the optical power monitoring device. The power level being measured by the optical power monitoring device represents the total optical power carried by the portion of the band represented by that slice. A super-channel may include a different quantity of spectral slices depending on the super-channel type.

Spectral loading, or channel loading, is the addition of one or more channel to a specific spectrum of light described by the light's wavelength in an optical signal. When all channels within a specific spectrum are being utilized, the specific spectrum is described as fully loaded. A grouping of two or more channels may be called a channel group. Spectral loading may also be described as the addition of one or more channel group to a specific spectrum of light described by the light's wavelength to be supplied onto the optical fiber as the optical signal.

As used herein, a transmission line segment (which may be referred to as an optical link or an optical multiplex section) is the portion of a transmission line from a first node (e.g., ROADM) transmitting a transmission signal to a second node (e.g., ROADM) receiving the transmission signal. The transmission line segment may include one or more optical ILA situated between the first node and the second node. In some implementations, an optical multiplex section (OMS) has the same scope as the transmission line segment (TLS). In some implementations, the OMS may be a subset of a TLS. In some implementations, OMS-C(C-Band) and OMS-L (L-Band) may be combined together in an optical link or TLS. In some implementations, TLS may be used synonymously with Optical Link. An Optical Link may be composed of OMS-C and OMS-L

As used herein, an optical span is a portion of an optical transmission line from a first network element (e.g., ROADM, optical amplifier, etc.) transmitting a transmission signal to a next network element (e.g., ROADM, optical amplifier, etc.) in the optical transmission line that receives the transmission signal. For instance, in an exemplary transmission line segment, a first optical span may connect a first ROADM to a first optical amplifier, a second optical span may connect the first optical amplifier to a second optical amplifier, and a third optical span may connect the second optical amplifier to a second ROADM.

Amplified spontaneous emission (ASE) is light produced by spontaneous emission that has been optically amplified by the process of stimulated emission in a gain medium. ASE is light that is incoherent and causes perturbations on the optical link. Every optical amplifier (e.g., EDFAs and Raman amplifiers) emit ASE. If an amplified spontaneous emission power level is too high relative to the transmission signal power level, the transmission signal in the optical fiber cable will be unreadable due to a low signal to noise ratio.

Transmission launch power may include a spectral power, which may be described in decibel-milliwatts (dBm or dBmW), of a transmission signal after each transmitter or amplifier.

A WSS (Wavelength Selective Switch) is a component used in optical communications networks to route (switch) optical signals between optical fibers on a per-slice basis. Generally, power level controls can also be done by the WSS by specifying an attenuation level on a passband filter. A Wavelength Selective Switch is a programmable device having source and destination fiber ports where the source and destination fiber ports and associated attenuation can be specified for a particular passband with a minimum bandwidth. The minimum bandwidth may be, for example, a slice. In one implementation, for example, the wavelength selective switch is operable to apply an attenuation for a particular passband having a first bandwidth and the optical power monitoring device has a resolution of a second bandwidth. The first bandwidth and the second bandwidth may be different (for example, the first bandwidth may be 12.5 GHz and the second bandwidth may be 3.125 GHz). In this implementation, then, the WSS may have a different slice width than the optical power monitor slice width.

As used herein, a reconfigurable optical add-drop multiplexer (ROADM) node refers to an all-optical subsystem that enables remote configuration of wavelengths at any ROADM node. In other words, a ROADM enables optical switching of an optical signal without requiring conversion of the optical signal from an optical domain into an electrical or digital domain. A ROADM is software-provisionable so that a network operator can choose whether a wavelength is added, dropped, or passed through the ROADM node. The technologies used within the ROADM node include wavelength blocking, planar light wave circuit (PLC), and wavelength selective switching (WSS)-though the WSS has become the dominant technology. A ROADM system is a metro/regional wavelength division multiplexing (WDM) or long-haul dense wavelength division multiplexing (DWDM) system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element. So, as the directions switched at a ROADM node increase, the ROADM node's cost increases.

An exemplary optical transport network consists of two distinct domains: Layer 0 (“optical domain” or “optical layer”) and Layer 1 (“digital domain”) data planes. Layer 0 is responsible for fixed or reconfigurable optical add/drop multiplexing (R/OADM) and optical amplification (EDFA or Raman) of optical channels and optical channel groups (OCG), typically within the 1530 nm-1565 nm range, known as C-Band. ROADM functions are facilitated via usage of a combination of colorless, directionless, and contentionless (CDC) optical devices, which may include wavelength selective switches (WSS), Multicast switches (MCS). Layer 0 may include the frequency grid (for example, as defined by ITU G.694.1), ROADMs, FOADMs, Amps, Muxes, Line-system and Fiber transmission, and GMPLS Control Plane (with Optical Extensions). Layer 1 functions encompass transporting client signals (e.g., Ethernet, SONET/SDH) in a manner that preserves bit transparency, timing transparency, and delay-transparency. The predominant technology for digital layer data transport in use today is OTN (for example, as defined by ITU G.709). Layer 1 may transport “client layer” traffic. Layer 1 may be a digital layer including multiplexing and grooming. The optical layer may further be divided into either an OTS layer or an OCH layer. The OTS layer refers to the optical transport section of the optical layer, whereas the OCH layer refers to one or more optical channels which are co-routed (e.g., together as multiple channels).

As used herein, tilt, also called linear power tilt, is defined as the linear change in power with wavelength over the signal spectrum per 1.0 THz. Due to Raman gain, short wavelength signals provide Raman gain for longer wavelengths. SRS Tilt strength, that is the difference in gain between the longest wavelength and the shortest wavelength of the signals, depends on the transmission signal power, spectral loading, fiber type, and fiber length. In one example, the tilt arises from power that is depleted from C-band signals to amplify L-band signals. Linear tilt slope can be defined in units of dB/THz. Tilt may occur in the C-Band, the L-Band, the C+L-Band, combinations thereof, and/or the like. Tilt may be described as linear tilt slope times amplifier bandwidth. For example only, assuming a linear tilt slope of 0.625 dB/THz, tilt in either the C-Band or L-Band would be (0.625 dB/THz*4.8 THz)=3 dB and, assuming a linear tilt slope of 0.4 dB/THz, tilt across both C-Band and L-Band would be (0.4 dB/THz*9.875 THz)=3.95 dB.

Referring now to the drawings and in particular to FIG. 1, shown therein is a diagrammatic view of an exemplary implementation of a system 10 comprising an optical transport network 22 (hereinafter, the “optical network 22”), one or more user devices 14 (hereinafter the “user device 14”), one or more network administration devices 16 (hereinafter “the network administration device 16”), and one or more graphical user interfaces 18 (hereinafter the “GUI 18”). A user 12 may interact with the system 10 using the user device 14, that may be used to request, from the network administration device 16, the GUI 18, which may be configured to accept input from the user 12 that may be transmitted to the network administration device 16 and/or one or more network elements 19 of the optical network 22.

The optical network 22 may comprise two or more network elements 19 (hereinafter, the “network elements 19”), such as a first network element 19a (hereinafter, the “headend network element 19a”) and a second network element 19b (hereinafter, the “tail-end network element 19b”), and a transmission line segment 23 connecting the headend network element 19a and the tail-end network element 19b. The headend network element 19a and the tail-end network element 19b may be optical nodes. One or more of the headend network element 19a and the tail-end network element 19b may be a reconfigurable add-drop multiplexer (ROADM) node.

The network administration device 16 may be connected to the headend network element 19a and the tail-end network element 19b in the optical network 22 and the user device 14 via a communication network 30. In some implementations, the network 30 may be the Internet and/or other network. For example, if the communication network 30 is the Internet, the GUI 18 of the system 10 may be delivered through a series of web pages or private internal web pages of a company or corporation, which may be written in hypertext markup language. It should be noted that the GUI 18 of the system 10 may be another type of interface including, but not limited to, a Windows-based application, a tablet-based application, a mobile web interface, an application running on a mobile device, and/or the like.

The communication network 30 may be almost any type of network. For example, in some embodiments, the communication network 30 may be a version of an Internet network (e.g., exist in a TCP/IP-based network). It is conceivable that in the near future, embodiments within the present disclosure may use more advanced networking technologies.

The optical network 22 may include any type of network that uses light as a transmission medium. For example, the optical network 22 may include a wavelength division multiplexed optical communication system, a fiber-optic based network, a laser diode network, an infrared network, and/or a combination of these or other types of optical networks.

The optical network 22 may be provided with one or more optical amplifiers 20, such as a first optical amplifier 20a and a second optical amplifier 20b. The transmission line segment 23 connects the headend network element 19a and the tail-end network element 19b and the optical amplifiers 20 in the optical network 22. The network administration device 16 may also be connected to and communicate with the optical amplifiers 20 via the network 30.

As used herein, “network devices 16, 19, 20” refers to one or more of the network administration device 16, the network element 19, and the optical amplifiers 20.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more function described as being performed by another one or more of the devices of the system 10. Devices of the system 10 may interconnect via wired connections, wireless connections, or a combination of wired and wireless connections.

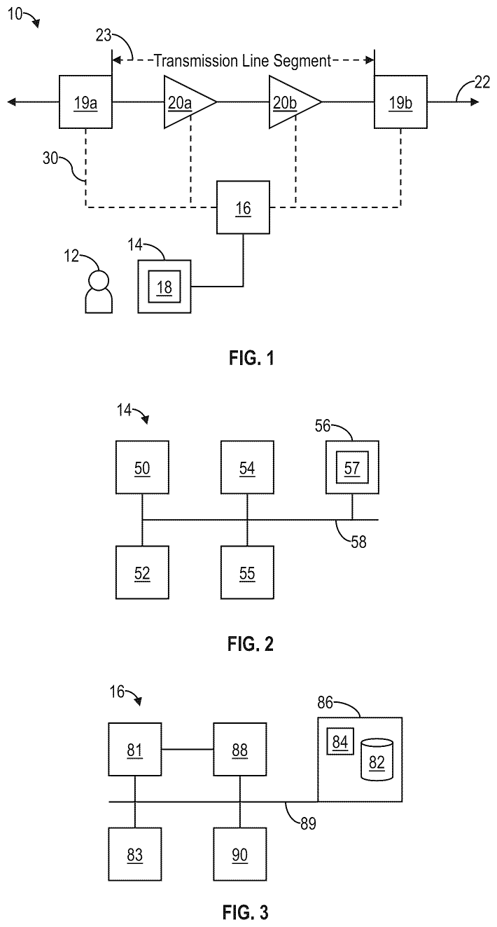

As shown in FIG. 2, the one or more user device 14 of the system 10 may include, but are not limited to, implementation as a personal computer, a cellular telephone, a smart phone, a network-capable television set, a tablet, a laptop computer, a desktop computer, a network-capable handheld device, a server, a digital video recorder, a wearable network-capable device, and/or the like.

In some implementations, the user device 14 may include one or more input device 50 (hereinafter “input device 50”), one or more output device 52 (hereinafter “output device 52”), one or more processor 54 (hereinafter “processor 54”), one or more communication device 55 (hereinafter “communication device 55”) capable of interfacing with the network 30, one or more non-transitory memory 56 (hereinafter “memory 56”) storing processor executable code and/or software application(s), including, for example, a web browser capable of accessing a website and/or communicating information and/or data over a wireless or wired network (e.g., network 30), and/or the like. The input device 50, output device 52, processor 54, communication device 55, and memory 56 may be connected via a path 58 such as a data bus that permits communication among the components of user device 14.

The memory 56 may store an application 57 that, when executed by the processor 54, causes the user device 14 to display the GUI 18. In some embodiments, the application 57 is programmed to cause the processor 54 to provide the GUI 18 that allows the user 12 to interact with both historical and real-time information gathered from the network devices 16, 19, 20 as will be described further herein. The input device 50 may be capable of receiving information input from the user 12 and/or processor 54, and transmitting such information to other components of the user device 14 and/or the communication network 30.

The input device 50 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The output device 52 may be capable of outputting information in a form perceivable by the user 12 and/or processor 54. For example, implementations of the output device 52 may include, but are not limited to, a computer monitor, a screen, a touchscreen, a speaker, a website, a television set, a smart phone, a PDA, a cell phone, a fax machine, a printer, a laptop computer, combinations thereof, and the like, for example. It is to be understood that in some exemplary embodiments, the input device 50 and the output device 52 may be implemented as a single device, such as, for example, a touchscreen of a computer, a tablet, or a smartphone. It is to be further understood that as used herein the term user 12 is not limited to a human being, and may comprise a computer, a server, a website, a processor, a network interface, a human, a user terminal, a virtual computer, combinations thereof, and/or the like, for example.

Returning to FIG. 1, the network administration device 16 may be capable of interfacing and/or communicating with the user device 14 via the communication network 30. For example, the network administration device 16 may be configured to interface by exchanging signals (e.g., analog, digital, optical, and/or the like) via one or more port (e.g., physical ports or virtual ports) using a network protocol, for example. Additionally, each network administration device 16 may be configured to interface and/or communicate with other network administration device 16 directly and/or via the communication network 30, such as by exchanging signals (e.g., analog, digital, optical, and/or the like) via one or more port.

The communication network 30 may permit bi-directional communication of information and/or data between the user device 14 and/or the network devices 16, 19, 20. The network 30 may interface with the user device 14 and/or the network devices 16, 19, 20 in a variety of ways. For example, in some embodiments, the communication network 30 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the communication network 30 may be implemented as the World Wide Web (or Internet), a local area network (LAN), a wide area network (WAN), a metropolitan network, a 4G network, a 5G network, a satellite network, a radio network, an optical network, a cable network, a public switch telephone network, an Ethernet network, combinations thereof, and the like, for example. Additionally, the communication network 30 may use a variety of network protocols to permit bi-directional interface and/or communication of data and/or information between the user device 14 and/or the network devices 16, 19, 20.

Referring now to FIG. 3, shown therein is a diagrammatic view of an exemplary implementation of the network administration device 16. The network administration device 16 may include one or more device that gather, process, search, store, and/or provide information in a manner described herein. In the illustrated embodiment, the network administration device 16 is provided with an input device 81 one or more database 82 (hereinafter “database 82”), program logic 84, and one or more processor 88 (hereinafter “processor 88”). The program logic 84 and the database 82 may be stored on non-transitory computer readable storage memory 86 (hereinafter “memory 86”) accessible by the processor 88 of the network administration device 16. It should be noted that as used herein, program logic is another term for instructions which can be executed by the processor 54 or the processor 88.

The database 82 can be a relational database or a non-relational database. Examples of such databases comprise, DB2®, Microsoft® Access, Microsoft® SQL Server, Oracle®, MySQL, PostgreSQL, MongoDB, Apache Cassandra, and the like. It should be understood that these examples have been provided for the purposes of illustration only and should not be construed as limiting the presently disclosed inventive concepts. The database 82 can be centralized or distributed across multiple systems.

In some embodiments, the network administration device 16 may comprise one or more processors 88 working together or independently to execute processor executable code stored on the memory 86. Additionally, each network administration device 16 may include at least one input device 81 (hereinafter “input device 81”) and at least one output device 83 (hereinafter “output device 83”). Each element of the network administration device 16 may be partially or completely network-based or cloud-based and may or may not be located in a single physical location.

The processor 88 may be implemented as a single processor or multiple processors working together or independently to execute the program logic 84 as described herein. It is to be understood that in certain embodiments using more than one processor 88, the processors 88 may be located remotely from one another, located in the same location, or comprising a unitary multi-core processor. The processors 88 may be capable of reading and/or executing processor executable code and/or capable of creating, manipulating, retrieving, altering, and/or storing data structures into the memory 86.

Exemplary embodiments of the processor 88 may include, but are not limited to, a digital signal processor (DSP), a central processing unit (CPU), a field programmable gate array (FPGA), a graphics processing unit (GPU), a microprocessor, a multi-core processor, combinations, thereof, and/or the like, for example. The processor 88 may be capable of communicating with the memory 86, the input device 81, the output device 83, and/or the communication device 90 via a path 89 (e.g., data bus).

The processor 88 may be further capable of interfacing and/or communicating with the user device 14, the network elements 19, and/or the optical amplifiers 20 via the network 30 using the communication device 90. For example, the processor 88 may be capable of communicating via the network 30 by exchanging signals (e.g., analog, digital, optical, and/or the like) via one or more port (e.g., physical or virtual ports) using a network protocol to provide a pump model to the optical amplifier 20 as will be described in further detail herein.

The memory 86 may be capable of storing processor executable code such as program logic 84. Additionally, the memory 86 may be implemented as a conventional non-transitory memory, such as for example, random access memory (RAM), CD-ROM, a hard drive, a solid-state drive, a flash drive, a memory card, a DVD-ROM, a disk, an optical drive, combinations thereof, and/or the like, for example.

In some embodiments, the memory 86 may be located in the same physical location as the processor 88, and/or one or more memory 86 may be located remotely from the processor 88. For example, the memory 86 may be located remotely from the processor 88 and communicate with the processor 88 via the communication network 30. Additionally, when more than one memory 86 is used, a first memory 86 may be located in the same physical location as the processor 88, and additional memory 86 may be located in a location physically remote from the processor 88. Additionally, the memory 86 may be implemented as a “cloud” non-transitory computer readable storage memory (i.e., one or more memory 86 may be partially or completely based on or accessed using the network 30).

The input device 81 of the network administration device 16 may transmit data to the processor 88 and may be similar to the input device 50 of the user device 14. The input device 81 may be located in the same physical location as the processor 88 or located remotely and/or partially or completely network-based. The output device 83 of the network administration device 16 may transmit information from the processor 88 to the user 12, and may be similar to the output device 52 of the user device 14. The output device 83 may be located with the processor 88, or located remotely and/or partially or completely network-based.

The memory 86 may store processor executable code and/or information comprising the database 82, program logic 84 (which may also be referred to as executable code), and the loading management module 92. In some embodiments, the processor executable code 84 may be stored as a data structure, such as the database 82 and/or data table, for example, or in non-data structure format such as in a non-compiled text file.

Returning to FIG. 1, each of the headend network element 19a and the tail-end network element 19b may include one or more devices that gather, process, store, and/or provide information in a manner described herein. For example, the headend network element 19a and the tail-end network element 19b may comprise one or more optical data processing and/or traffic transfer devices, such as an optical add-drop multiplexer (“OADM”), a reconfigurable optical add-drop multiplexer (“ROADM”), or a flexibly reconfigurable optical add-drop multiplexer module (“FRM”), and/or any type of device capable of processing and/or transferring optical traffic.

In some implementations, the headend network element 19a and the tail-end network element 19b may comprise OADMs and/or ROADMs capable of being configured to add, drop, multiplex, and demultiplex optical signals. The headend network element 19a and the tail-end network element 19b may process and transmit optical signals to other network elements 19 (not shown) throughout the optical network 22 in order to deliver optical transmissions.

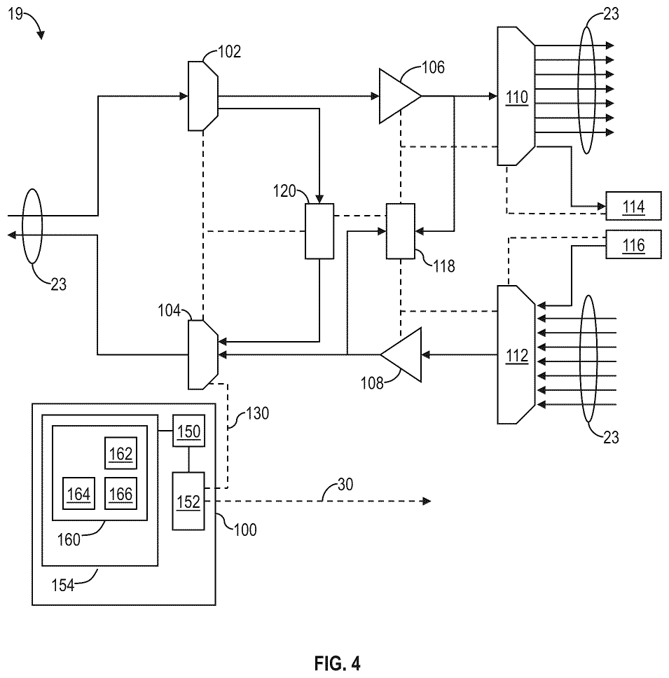

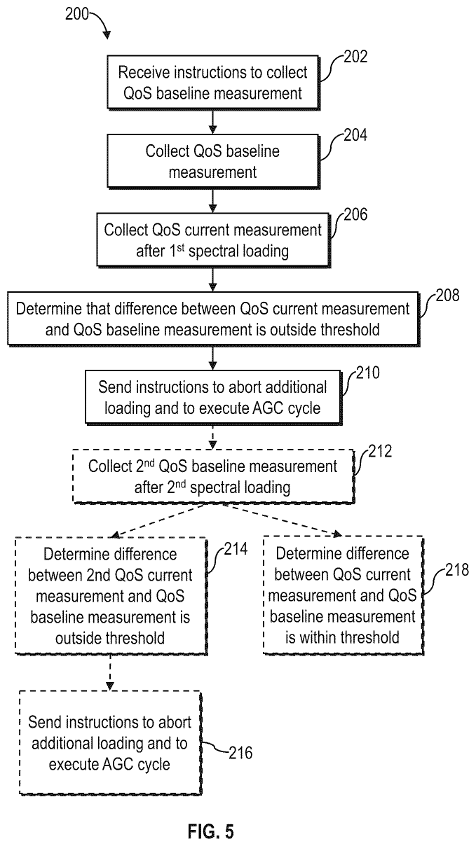

Referring now to FIG. 4, shown therein is a diagrammatic view of an exemplary implementation of the network element 19 of the optical network 22 that may be configured according to implementations described herein. The headend network element 19a and the tail-end network element 19b may be constructed similarly as the network element 19, described below. In accordance with the present disclosure, the network element 19 may be a ROADM within the fiber of the optical network 22.

The network element 19 may comprise a controller 100, an input filter 102, an output filter 104, an input amplifier 106, an output amplifier 108, a de-multiplexer (DEMUX) WSS 110, a multiplexer (MUX) WSS 112, at least one drop transceiver 114, at least one add transceiver 116, an optical channel monitor (OCM) 118, and an optical supervisory channel (OSC) 120. It should be noted that the elements of the network element 19 are shown for illustration purposes only and should not be considered limiting. For instance, the network element 19 illustrated is one possible realization of a single degree of a ROADM. However, illustrated network element 19 may be implemented as a multi-degree ROADM with a launch power for each transmission line segment 23 serviced by illustrated implemented in accordance with the inventive concepts described herein. Further, the at least one drop transceiver 114 and the at least one add transceiver 116 may be implemented as a line card having multiple add and drop transceivers and may be configured to service channels across multiple ROADM degrees.

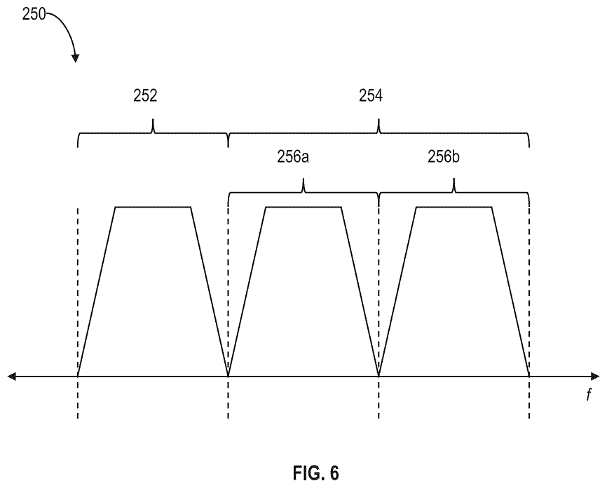

The DEMUX WSS 110 and the MUX WSS 112 of the network element 19 may be components that can dynamically route, block, and/or attenuate received optical signals (shown in FIG. 6) input from and output to the transmission line segment 23. In addition to transmitting and/or receiving optical signals from the network element 19, optical signals may also be input from or output to the add transceiver 116 and the drop transceiver 114, respectively.

In one implementation, each of the DEMUX WSS 110 and the MUX WSS 112 may be a reconfigurable, optical filter operable to allow one or more passbands (e.g., particular bandwidth(s) of the spectrum of the optical signal (such as the optical signal portion 250 shown in FIG. 6)) to pass through or be routed as herein described.

In one implementation, the DEMUX WSS 110 (i.e., can receive optical signals and may be operable to selectively switch, or direct, such optical signals to one or more other WSS for output from the network element 19). The DEMUX WSS 110 may also selectively or controllably supply optical signals to the drop transceiver 114.

In one implementation, the DEMUX WSS 110 may apply attenuations and filtering to an incoming optical signal before demultiplexing the incoming optical signal into one or more express optical signals or one or more drop optical signals.

The MUX WSS 112 may be operable to selectively receive optical signals (shown in FIG. 6) from the add transceiver 116 in the network element 19 and from one or more express path, such as from an upstream network element 19). The optical signals output from the add transceiver 116 and/or from the express path may be selectively supplied to the MUX WSS 112 for output to the transmission line segment 23.

The OCM 118 is configured to monitor a power level of each wavelength. This dynamic datapoint can then be used by the controller 100 to attenuate each wavelength with the DEMUX WSS 110 and/or the MUX WSS 112 at ROADM sites or dynamic gain equalization (DGE) at optical amplifier 20 sites in order to optimize the power level of each wavelength. The OCM 118 can also be used to troubleshoot the optical network 22. The OCM 118 may be a flexible-grid OCM and/or a higher-resolution coherent OCM and/or a coherent OCM. Coherent OCMs offer sub-GHz accuracy and highly accurate power monitoring of fine spectral slices independent of adjacent channel power. Coherent OCMs reduce the C-band scanning time from seconds to hundreds of milliseconds and provide advanced processing of spectral characteristics, such as valid channel detection, center wavelength, and optical signal-to-noise ratio (OSNR).

The OSC 120 provides a communication channel between adjacent nodes such as the headend network element 19a and the tail-end network element 19b that may be used for functions including link control, in-band management, control plane (i.e., ASON/GMPLS), and/or span loss measurement. Static datapoints associated with the transmission line segment 23 (e.g., fiber types, loss, amplifier types, etc.) downstream from the network element 19 can be communicated to the controller 100 via the OSC 120.

The network element 19 is illustrated with the controller 100 for controlling the elements of the network element 19. The network element 19 may be provided with an interface 130 that connects the controller 100 to the elements of the network element 19.

The controller 100 may be a microcontroller, for instance, that is provided with a processor 150, a communication device 152, and a non-transitory computer readable memory 154 (“memory 154”). The memory 154 may store a loading management module 160 that may be used to dynamically edit, install, and/or activate loading policies that may be used to configure spectral loading in the transmission line segment 23 of the optical network 22 and to perform tasks, as will be described in further detail herein.

The number of devices illustrated in FIG. 4 are provided for explanatory purposes. In practice, there may be additional devices, fewer devices, different devices, or differently arranged devices than are shown. Furthermore, two or more of the devices illustrated in FIG. 4 may be implemented within a single device, or a single device illustrated in FIG. 4 may be implemented as multiple, distributed devices. Additionally, one or more of the devices illustrated in FIG. 4 may perform one or more function described as being performed by another one or more of the devices illustrated. Devices illustrated in FIG. 4 may interconnect via wired connections (e.g., fiber-optic connections).

Referring now to FIG. 6, shown therein is an exemplary workflow diagram of a QoS feedback method 200 for managing spectral loading of a transmission line segment 23.

If one band (C band will be used for the purposes of illustration) is loaded and then channels are loaded in the other band (the L band in this example), Raman tilt may be created. Raman tilt is defined (in dB) as the difference between the power (in dB) of the longest wavelength channel and the power (in dB) of the shortest wavelength channel in the already loaded spectrum. The Raman tilt, or effect, becomes particularly pronounced when an appreciable level of optical power distributed over a certain range of wavelengths is pumped into an optical fiber. In that instance, the Raman gain is tilted in favor of the channels having the longer wavelengths. During transmission on the optical fiber, such as the transmission line segment 23, the Raman effect attenuates the power levels of the optical channels of the lower wavelengths, but increases the power levels of the optical channels of the higher wavelengths by shifting the power from the former channels to the latter channels. The Raman tilt thus degrades the Signal-to-Noise Ratio (SNR) of the signals in the lower wavelength channels and thus seriously degrades performance of the lower wavelength channels. The Raman tilt also degrades the long wavelength channels by increasing the power of the channels beyond the optimum and increasing the non-linear penalties.

As disclosed in U.S. Patent Application Publication No. 2023/0327762 A1, titled “Method of Transient Management in Optical Transmission Systems”, which is hereby incorporated by reference in its entirety herein, to counter Raman tilt, loading policies for service activation may recommend an order in which to load the new channels on the L band based on the current loading of the C band spectrum, the region of the L band into which the new channels are to be loaded, and/or the power of the wavelengths of the channels to be loaded, for instance, in a current loading management operation cycle. In another example, a loading policy may be created that takes into account how full a band currently is. In another example, a loading policy may be created that targets a predetermined QoS metric. For instance, one or more passband and one or more corresponding loading management operation may be selected in such a way as to limit a transient power excursion of one or more active optical service on the transmission line segment 23 to be less than a predetermined power (in dB) during execution of the one or more selected loading management operation. Loading policies may be dynamically created and/or edited that allow the user to change a spectral loading pattern for a given set of parameters impacting a transmission line segment 23 while the transmission line segment 23 is operational.

Referring now to FIG. 6, shown therein is an exemplary signal portion 250 of an optical signal for loading. Generally, the loading management operations may identify a passband spanning a single wavelength, such as the first passband 252 shown in FIG. 6. However, in some implementations, at least one of the loading management operations in the pending list may identify at least one passband spanning a plurality of wavelengths, such as the second passband 254 shown in FIG. 6. In such implementations, the passband may be separated into a plurality of sub-passbands, such as the first sub-passband 256a and the second sub-passband 256b shown in FIG. 6, which may allow spectral loading with more granularity. Accordingly, for example, an activation may be executed on the first sub-passband 256a in a first operation cycle and the second sub-passband 256b may be added to the deferred pending list for execution in one or more subsequent operation cycles.

Returning now to FIG. 6, for the purposes of illustration, the method 200 will be described using an implementation of the system 10 operating from the tail-end network element 19b in conjunction with the headend network element 19a. However, it should be noted that the method 200 described would operate substantially the same in an implementation of the system 10 wherein control of the method 200 is run from the network administration device 16, a centralized orchestrator, and/or a cloud-based controller, operating on the network elements 19.

The non-transitory computer readable memory 154 of the tail-end network element 19b may store instructions that, when executed by the processor of the tail-end network element 19b, cause the processor of the tail-end network element 19b to carry out steps of the method 200. Likewise, the non-transitory computer readable memory 154 of the headend network element 19a may store instructions that, when executed by the processor of the headend network element 19a, cause the processor of the headend network element 19a to carry out steps of the method 200.

In a step 202, the tail-end network element 19b may receive instructions, sent from the headend network element 19a on the transmission line segment 23, to collect a quality-of-service (QoS) baseline measurement of QoS data. The QoS data may be indicative of performance of an optical carrier on the transmission line segment 23. The QoS data may be indicative of optical disturbance of data traffic on the transmission line segment 23.

In some implementations, the tail-end network element 19b may receive instructions, sent from the headend network element 19a on the transmission line segment 23, to collect two or more quality-of-service (QoS) baseline measurements of respective ones of two or more types of QoS data.

The QoS data may be determined to be one or more data sets that are indicative of the “health” of the existing services.

In some implementations, the QoS data may comprise one of more of the following: transceiver performance margins for traffic-carrying services already on the transmission line segment; line-side band-level monitor photodiode values at the network element; monitor photodiode values at downstream network elements; and transponder carrier Q-factor performance values.

In some implementations in which downstream network elements 19 in the optical network 22 comprise one or more ROADM express and ROADM drop ports; the QoS data may comprise ROADM optical power monitoring (OPM) trace data and/or metrics derived and/or calculated from the OPM trace data. Metrics derived and/or calculated from the OPM trace data may include, for example, per carrier power, carrier power spectral density, and so on.

The headend network element 19a may run a first automatic gain control cycle (AGC) before sending instructions to the tail-end network element 19b to collect the QoS baseline measurement.

In a step 204, the tail-end network element 19b may collect the QoS baseline measurement. As one example, the tail-end network element 19b may collect line-side band-level monitor photodiode values to be used as the QoS baseline measurement. In some implementations, the tail-end network element 19b may collect two or more quality-of-service (QoS) baseline measurements of respective ones of two or more types of QoS data. As one example, the tail-end network element 19b may collect line-side band-level monitor photodiode values to be used as the QoS baseline measurement for line-side band-level monitor photodiode values and the tail-end network element 19b may collect transponder carrier Q-factor performance values to be used as the QoS baseline measurement for transponder carrier Q-factor performance values.

In some implementations, the QoS baseline measurement may be compared against a similar data set taken after a previous AGC cycle, and/or re-validated immediately after capture. If the data in the QoS baseline measurement has changed by more than a predetermined acceptable amount since the last AGC cycle, the AGC cycle may be re-run by the headend network element 19a and then the tail-end network element 19b may collect a new QoS baseline measurement of the QoS data.

In a step 206, after a first spectral loading operation is performed on the transmission line segment 23 by the headend network element 19a, the tail-end network element 19b may collect a QoS current measurement of the QoS data. As one example, the tail-end network element 19b may collect line-side band-level monitor photodiode values to be used as the QoS current measurement. In some implementations, the tail-end network element 19b may collect two or more quality-of-service (QoS) current measurements of respective ones of two or more types of QoS data. As one example, the tail-end network element 19b may collect line-side band-level monitor photodiode values to be used as the QoS current measurement for line-side band-level monitor photodiode values and the tail-end network element 19b may collect transponder carrier Q-factor performance values to be used as the QoS current measurement for transponder carrier Q-factor performance values.

In a step 208 of the method 200, the tail-end network element 19b may determine that a numerical difference between the QoS current measurement and the QoS baseline measurement is outside of a predetermined threshold. The predetermined threshold may be a predetermined range of values, a maximum value, or a minimum value, for example.

The tail-end network element 19b may determine that the difference between the QoS current measurement and the QoS baseline measurement is outside of the predetermined threshold by comparing the difference to the predetermined threshold, such as by comparing the value of the difference to a predetermined range of values, a predetermined maximum value, and/or a predetermined minimum value.

In implementations in which two or more QoS current measurements of respective ones of two or more types of the QoS data are collected, the tail-end network element 19b may determine that one or more numerical difference between each of the QoS current measurements and respective ones of the QoS baseline measurements is outside of a respective predetermined threshold, where the respective predetermined thresholds are set for each of the types of the QoS data.

The respective predetermined thresholds for the one or more data sets may be a proxy for a predetermined level of optical disturbance on existing traffic of the optical network 22 considered to be acceptable. The predetermined thresholds may be chosen in order to scale the aggression of the loading operations such that more/less tail-end QoS parameter deviation is permitted, thereby allowing more/less quantity of loading operations per AGC cycle. Different predetermined thresholds may be used to validate the baseline data, versus exiting from the list of planned loading operations before all operations are complete.

In a step 210, the tail-end network element 19b may send instructions to the headend network element 19a to abort a second spectral loading operation for the transmission line segment 23 and to execute another automatic gain control (AGC) cycle to adjust amplifier operating conditions in a manner aimed at bringing the QoS measurement inside the predetermined threshold.

For example, adjusting amplifier operating conditions may comprise adjusting amplifier operating conditions to reduce Stimulated Raman Scattering (SRS) optical disturbances.

The headend network element 19a may execute the AGC cycle to adjust the amplifier operating conditions. The headend network element 19a may then execute a second spectral loading operation to load additional channels or subchannels to the transmission line segment 23.

Alternatively to carrying out step 208 and step 210, the tail-end network element 19b may determine that the QoS current measurement is inside of the predetermined threshold. In some implementations, the tail-end network element 19b may send a confirmation to the headend network element 19a that the QoS current measurement is satisfactory.

In some implementations, the tail-end network element 19b may communicate a “Pass” or “Fail” criteria to the headend network element 19a after every threshold check is performed. The communication of Pass or Fail feedback messages may be done on a service-by-service basis, which may be useful if some services are considered non-critical and the decision to abort loading is discretional, or may be grouped such that if any one service fails its threshold check, then the headend network element 19a aborts spectral loading. The Pass feedback message or Fail feedback message takes the minimum resource to communicate, as it may be a single Boolean value. The Pass or Fail feedback messages are prioritized (next to fault notifications) in the communication infrastructure to optimize feedback timing.

Optionally, in some implementations, after the second spectral loading operation of the headend network element 19a on the transmission line segment 23, in a step 212 the tail-end network element 19b may collect a second QoS current measurement of the QoS data.

The tail-end network element 19b may compare the second QoS current measurement to the QoS baseline measurement and may determine that a numerical difference between the second QoS current measurement and the QoS baseline measurement is outside of a second predetermined threshold, in an optional step 214. In some implementations, the second predetermined threshold is the same as the first predetermined threshold. In some implementations, the second predetermined threshold is different than the first predetermined threshold.

Optionally, in a step 216, the tail-end network element 19b may send instructions to the headend network element 19a to abort a third spectral loading operation for the transmission line segment 23 and to execute another AGC cycle to adjust the amplifier operating conditions.

In some implementations, optionally, in a step 218, the tail-end network element 19b may determine that a numerical difference between the first QoS current measurement or the second QoS current measurement (or a QoS current measurement collected after the third spectral loading operation or later spectral loading operation) and the QoS baseline measurement is within the predetermined threshold, and may allow the headend network element 19 to continue spectral loading. In some implementations, the tail-end network element 19b may send a confirmation to the headend network element 19a that the second QoS current measurement is satisfactory.

In some implementations, one or more of the steps of the method 200 may be iterative.

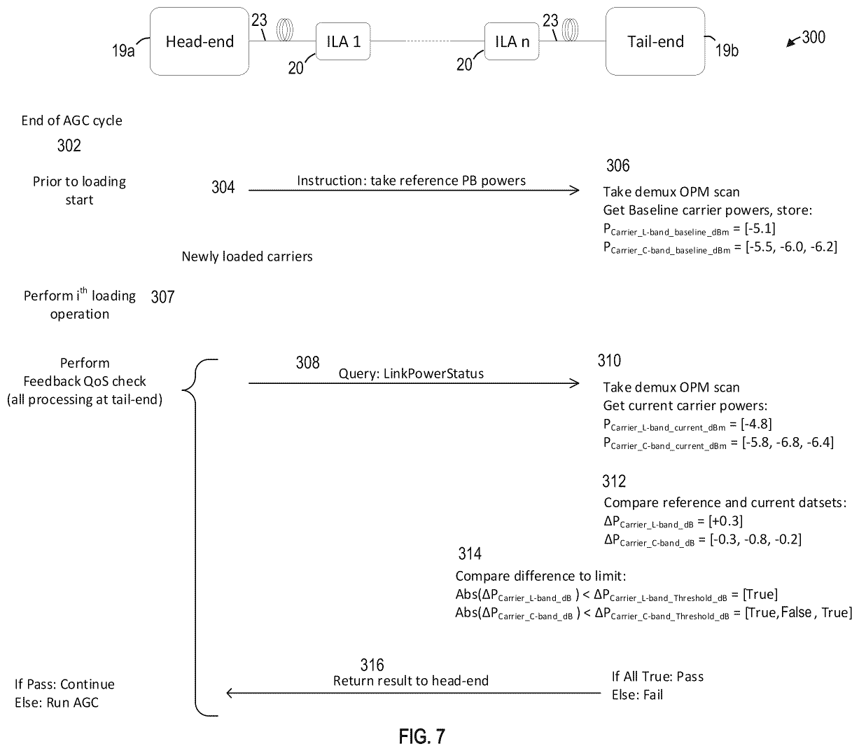

Turning now to FIG. 7, shown therein is a hypothetical example 300 of the QoS feedback method 200 in use, illustrating the flow of the steps. In this example, the QoS parameters are carrier powers of all in-service carriers as measured by taking OPM scans of the optical spectrum at the tail-end network element 19b and processing the resulting OPM data. The example illustrates new carriers being loaded into C+L optical spectra otherwise populated with ASE idlers, though ASE population is not a requirement for the use of the QoS feedback method 200.

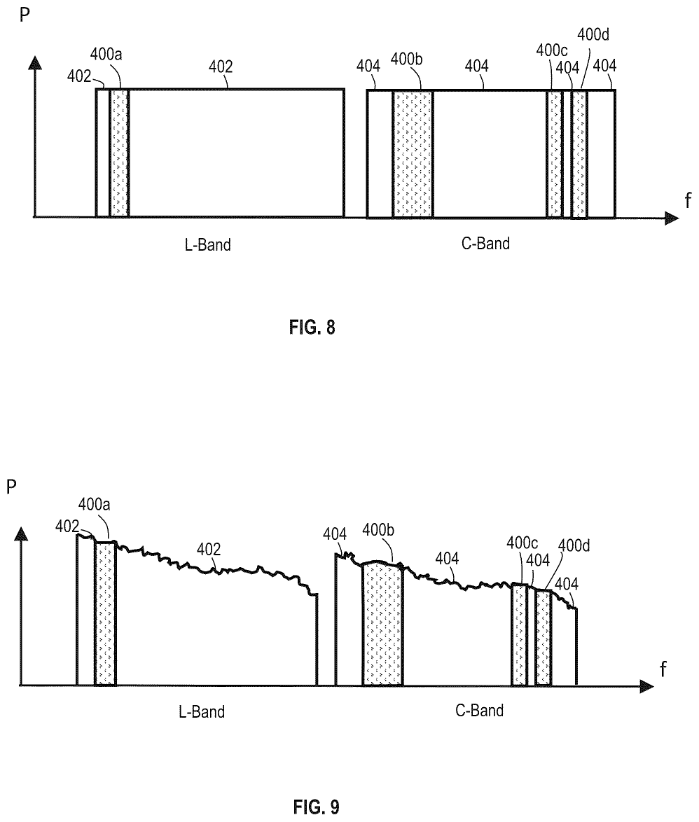

At the end of an initial AGC cycle (step 302), the headend network element 19a transmits service carriers into the transmission line segment 23. In this example, the C-band and L-band carry a first, second, third, and fourth in-service carriers 400a, 400b, 400c, and 400d, and have spectra populated with ASE idlers, shown as ASE-L 402 and ASE-C 404, in FIG. 8. FIG. 8 shows the optical spectrum of the exemplary signal transmitted into the fiber (transmission line segment 23) at the headend network element 19a after the initial AGC cycle (step 302).

Prior to the first loading operation, the headend network element 19a may instruct the tail-end network element 19b to take the QoS baseline measurement of the QoS data (step 304).

The tail-end network element 19b takes the QoS baseline measurement of the QoS data (step 306). FIG. 9 illustrates the received spectral signals at the tail-end network element 19b prior to the first loading operation and being received when the tail-end network element 19b collects the QoS baseline measurement of the QoS data. As shown in FIG. 7, in this example, the tail-end network element 19b takes a demux OPM scan, processes the resulting OPM data to calculate the baseline carrier powers data values, and stores the QoS baseline measurement.

Next, the headend network element 19a loads new carriers to the L-band and/or the C-band (step 307). The loading operation scheme may be that detailed in U.S. Patent Application Publication 2023/0327762 A1, titled “Method of Transient Management in Optical Transmission Systems”, for example, or other loading operation schemes.

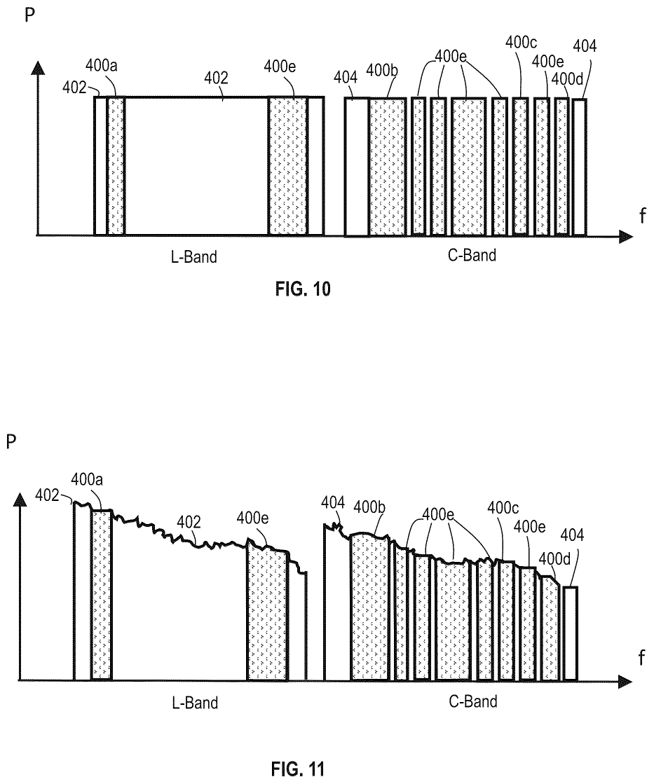

FIG. 10 illustrates exemplary newly loaded carriers 400e at the headend network element 19a on the transmission line segment 23, while FIG. 11 illustrates the exemplary received spectral signals with the newly loaded carriers 400e at the tail-end network element 19b.

Returning to FIG. 7, after every spectral loading operation (i^{t}h loading operation) by the headend network element 19a, a QoS current measurement is taken (step 310) by the tail-end network element 19b. The tail-end network element 19b may compare the QoS current measurement to the QoS baseline measurement (step 312) to determine a numerical difference between the QoS current measurement and the QoS baseline measurement. In step 314, the numerical difference between the QoS current measurement and the QoS baseline measurement is compared to the predetermined threshold (or limit).

Specifically, the headend network element 19a may instruct the tail-end network element 19b to perform a QoS check (step 308). In this example, the tail-end network element 19b may collect the QoS current measurement by taking a new OPM scan and measuring the current in-service carrier powers (step 310). In this example, the current in-service carrier powers are measured to be the following (in dBm per carrier):
Pcarrier_L-band_current_dBm=[−4.8]
Pcarrier_C-band_current_dBm=[−5.8, −6.8, −6.4]

In this example, one of the carriers 400 is observed to have changed by 0.8 dB compared to the QoS baseline measurement (step 312) as shown below.
deltaPcarrier_L-band_dB=[+0.3]
deltaPcarrier_C-band_dB=[−0.3, −0.8, −0.2]

The change is compared to the predetermined threshold (step 314) and is determined to be outside the predetermined threshold by the tail-end network element 19b, as shown below.
Abs(deltaPcarrier_L-band_dB)<deltaPcarrier_L-band_dB=[True]
Abs(deltaPcarrier_C-band_dB)<deltaPcarrier_C-band_dB=[True, False, True]

Therefore, the tail-end network element 19b returns a FAIL result to the headend network element 19a in step 316.

A FAIL result triggers the headend network element 19a to abort the next planned loading operation and run an AGC cycle. The headend network element 19a may store instructions that cause the headend network element 19a to abort the next planned loading operation and run an AGC cycle when a FAIL result is received. If the difference between the QoS current measurement and the QoS baseline measurement was within the predetermined threshold, then the tail-end network element 19b may return a PASS result to the headend network element 19a, and the headend network element 19a may continue loading operations without adding an AGC cycle. In some implementations, if no message is returned from the tail-end network element 19b to the headend network element 19a within a predetermined time frame, the headend network element 19a may continue loading operations without adding an AGC cycle.

In some implementations, the communication of Pass or Fail feedback messages may be done on a service-by-service basis. In the example of FIG. 7, in which the QoS data is per-carrier power values, then in step 314, each metric for each carrier is validated against the predetermined threshold for that metric, on a per-service basis, such as the following:
Abs(deltaPcarrier_L-band_dB)<deltaPcarrier_L-band_dB=[True]
Abs(deltaPcarrier_C-band_dB)<deltaPcarrier_C-band_dB=[True, False, True]

Then, as part of the step 316, the tail-end network element 19b may then aggregate all the per-service responses, such as by applying a logical check that if all metric checks are good and meet the respective predetermined threshold, then PASS, and if one or more checks are bad and do not meet the respective predetermined threshold, then FAIL.

In some implementations, in the step 316, the tail-end network element 19b may return only a single Pass/Fail response to the headend network element 19a. This simplifies the logic and limits the amount of information passed back and forth between the tail-end network element 19b and the headend network element 19a.

In some implementations, in the step 316, the tail-end network element 19b may reply with a detailed status message containing the specific per-service pass/fail information determined from step 314. This then gives the headend network element 19a more options to apply interesting and complex logic, especially if using multiple metrics to make the pass/fail decision.

For example, in a case in which the tail-end network element 19b determines from step 314 that Abs(deltaPcarrier_C-band_dB)<deltaPcarrier_C-band_dB=[True, False, True], if a second carrier has a lower priority than the other services (for example, because of more relaxed service-level agreement, lower pricing tier, etc.), then, in some cases, the headend network element 19a may determine that the deviation outside of the predetermined threshold for that type of QoS data (here, the False determination) is acceptable and does not warrant an AGC cycle to be run by the headend network element 19a.

In some implementations, the determination as to whether or not to run the AGC cycle may occur at the tail-end network element 19b, and/or the headend network element 19a and/or an SDN controller. In some implementations, the SDN controller may run on the network administration device 16 and/or the cloud.

As another example, if two or more types of QoS data are monitored, the respective types of QoS data may be given a priority ranking. For example, if two types of QoS data are used, such as power excursion and Q factor, and the power excursion is given a lower (less important) priority ranking than the Qfactor (since Qfactor is an indicator of signal quality), then if the power excursion of the service exceeds its respective predetermined threshold but the Q factor does not exceed its respective predetermined threshold, then the AGC cycle is not run by the headend network element 19a, because the signal did not degrade.

In some implementations, the QoS baseline measurement (from step 306) and subsequent QoS current measurement (from step 310) may be streamed to the headend network element 19a or an SDN controller and comparison logic (such as steps 312 and 314) may be performed there. This will have higher bandwidth overhead and timing requirements, but provides the headend network element 19a a complete set of information to act upon in determining whether to run an AGC cycle and/or continue spectral loading.

The method 200 significantly improves overall system performance, improving the balance between stability with operating timing while maintaining the required quality of service. This feedback mechanism improves overall system timing performance, allowing more loading operations to be serialized without executing a time-consuming AGC cycle, unless the feedback deems it necessary.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation.

What is claimed is:

1. A network element, comprising:
a processor; and
a non-transitory computer readable memory storing instructions that, when executed by the processor, cause the processor to:
receive, from a headend network element on a transmission line segment, instructions to collect a quality-of-service (QoS) baseline measurement of QoS data, wherein the QoS data is indicative of performance of an optical carrier on the transmission line segment;
collect the QoS baseline measurement;
collect a QoS current measurement of the QoS data, after a first spectral loading operation is performed on the transmission line segment by the headend network element;
determine that a numerical difference between the QoS current measurement and the QoS baseline measurement is outside of a predetermined threshold; and
send instructions to the headend network element to abort a second spectral loading operation for the transmission line segment and to execute an automatic gain control (AGC) cycle to adjust amplifier operating conditions.

2. The network element of claim 1, wherein the QoS data comprises transceiver performance margins for traffic-carrying services already on the transmission line segment.

3. The network element of claim 1, wherein the QoS data comprises line-side band-level monitor photodiode values at the network element.

4. The network element of claim 1, wherein the QoS data comprises monitor photodiode values at downstream network elements.

5. The network element of claim 4, wherein the downstream network elements comprise one or more ROADM express and ROADM drop ports.

6. The network element of claim 1, wherein the QoS data comprises ROADM optical power monitoring (OPM) trace data and metrics derived from the OPM trace data.

7. The network element of claim 1, wherein the QoS data comprises transponder carrier Q-factor performance.

8. The network element of claim 1, wherein the predetermined threshold is a predetermined range of values.

9. The network element of claim 1, wherein adjusting amplifier operating conditions comprises adjusting amplifier operating conditions to reduce Stimulated Raman Scattering (SRS) optical disturbances.

10. The network element of claim 1, wherein the QoS current measurement is a first QoS current measurement, the AGC cycle is a first AGC cycle, wherein the predetermined threshold is a first predetermined threshold, and wherein the non-transitory computer readable memory stores instructions that, when executed by the processor, cause the processor to:
collect a second QoS current measurement of the QoS data, after a second spectral loading operation of the headend network element;
determine that a numerical difference between the second QoS current measurement and the QoS baseline measurement is outside of a second predetermined threshold, wherein the second predetermined threshold is different than the first predetermined threshold; and
send instructions to the headend network element to abort a third spectral loading operation for the transmission line segment and to execute a second AGC cycle to adjust the amplifier operating conditions.

11. The network element of claim 1, wherein the QoS current measurement is a first QoS current measurement, the AGC cycle is a first AGC cycle, and wherein the non-transitory computer readable memory stores instructions that, when executed by the processor, cause the processor to:
collect a second QoS current measurement of the QoS data, after a second spectral loading operation of the headend network element; and
determine that a numerical difference between the second QoS current measurement and the QoS baseline measurement is within the predetermined threshold.

12. An optical network, comprising:
a headend network element comprising a headend processor and a headend non-transitory computer readable memory;
a tail-end network element comprising a tail-end processor and a tail-end non-transitory computer readable memory; and
a transmission line segment connecting the headend network element and the tail-end network element; and
wherein the tail-end non-transitory computer readable memory stores instructions that, when executed by the tail-end processor, cause the tail-end processor to:
receive, from the headend network element through the transmission line segment, instructions to collect a quality-of-service (QoS) baseline measurement of QoS data, wherein the QoS data is indicative of performance of an optical carrier on the transmission line segment;
collect the QoS baseline measurement;
collect a QoS current measurement of the QoS data, after a first spectral loading operation is performed on the transmission line segment by the headend network element;
determine that a numerical difference between the QoS current measurement and the QoS baseline measurement is outside of a predetermined threshold; and
send instructions to the headend network element to abort a second spectral loading operation for the transmission line segment and to execute an automatic gain control (AGC) cycle to adjust amplifier operating conditions; and
wherein the headend non-transitory computer readable memory stores instructions that, when executed by the headend processor, cause the headend processor to:
abort the second spectral loading operation for the transmission line segment;
execute the AGC cycle to adjust the amplifier operating conditions; and
perform a second spectral loading operation on the transmission line segment.

13. The optical network of claim 12, wherein the QoS current measurement is a first QoS current measurement, the AGC cycle is a first AGC cycle, and wherein the tail-end non-transitory computer readable memory stores instructions that, when executed by the tail-end processor, cause the tail-end processor to:
collect a second QoS current measurement of the QoS data, after the second spectral loading operation of the headend network element;
determine that a numerical difference between the second QoS current measurement and the QoS baseline measurement is outside of the predetermined threshold; and
send instructions to the headend network element to abort a third spectral loading operation for the transmission line segment and to execute a second AGC cycle to adjust the amplifier operating conditions.

14. The optical network of claim 12, wherein the QoS current measurement is a first QoS current measurement, the AGC cycle is a first AGC cycle, wherein the predetermined threshold is a first predetermined threshold, and wherein the tail-end non-transitory computer readable memory stores instructions that, when executed by the tail-end processor, cause the tail-end processor to:
collect a second QoS current measurement of the QoS data, after the second spectral loading operation by the headend network element;
determine that a numerical difference between the second QoS current measurement and the QoS baseline measurement is outside of a second predetermined threshold, wherein the second predetermined threshold is different than the first predetermined threshold; and
send instructions to the headend network element to abort a third spectral loading operation for the transmission line segment and to execute a second AGC cycle to adjust the amplifier operating conditions.

15. The optical network of claim 12, wherein the QoS current measurement is a first QoS current measurement, the AGC cycle is a first AGC cycle, and wherein the tail-end non-transitory computer readable memory stores instructions that, when executed by the tail-end processor, cause the tail-end processor to:
collect a second QoS current measurement of the QoS data, after the second spectral loading operation of the headend network element;
determine that a numerical difference between the second QoS current measurement and the QoS baseline measurement is within the predetermined threshold; and
wherein the headend non-transitory computer readable memory stores instructions that, when executed by the headend processor, cause the headend processor to:
subsequent to the determination that the numerical difference is within the predetermined threshold, perform a third spectral loading operation for the transmission line segment.

16. The optical network of claim 12, wherein adjusting amplifier operating conditions comprises adjusting amplifier operating conditions to reduce Stimulated Raman Scattering (SRS) optical disturbances.

17. The optical network of claim 12, wherein the AGC cycle is a second AGC cycle, the QoS baseline measurement is a first QoS baseline measurement, and wherein the tail-end non-transitory computer readable memory stores instructions that, when executed by the tail-end processor, cause the tail-end processor to:
collect a comparative QoS baseline measurement after a first AGC cycle is run by the headend processor and before the first QoS baseline measurement is collected;
compare the comparative QoS baseline measurement and the first QoS baseline measurement to determine that a numerical difference between the comparative QoS baseline measurement and the first QoS baseline measurement is greater than a predetermined difference maximum;
instruct the headend network element to run a third AGC cycle; and
collect a second QoS baseline measurement.

18. The optical network of claim 12, wherein the predetermined threshold is a predetermined range of values.

19. The optical network of claim 12, wherein the QoS data comprises one or more types of data comprising one or more of: data indicative of transceiver performance margins for traffic-carrying services already on the transmission line segment, line-side band-level monitor photodiode values at the tail-end network element; monitor photodiode values at downstream network elements; ROADM optical power monitoring (OPM) trace data and metrics derived from the OPM trace data; and transponder carrier Q-factor performance data.

20. An optical network, comprising:
a headend network element comprising a headend processor and a headend non-transitory computer readable memory;
a tail-end network element comprising a tail-end processor and a tail-end non-transitory computer readable memory; and
a transmission line segment connecting the headend network element and the tail-end network element; and
wherein the tail-end non-transitory computer readable memory stores instructions that, when executed by the tail-end processor, cause the tail-end processor to:
receive, from the headend network element through the transmission line segment, instructions to collect a quality-of-service (QoS) baseline measurement of QoS data, wherein the QoS data is indicative of performance of an optical carrier on the transmission line segment; and
collect the QoS baseline measurement; and
collect a QoS current measurement of the QoS data, after a first spectral loading operation is performed on the transmission line segment by the headend network element; and
send the QoS baseline measurement and the QoS current measurement to the headend network element;
wherein the headend non-transitory computer readable memory stores instructions that, when executed by the headend processor, cause the headend processor to:
receive the QoS baseline measurement and the QoS current measurement;
determine that a numerical difference between the QoS current measurement and the QoS baseline measurement is outside of a predetermined threshold by comparing the QoS current measurement to the QoS baseline measurement;
abort a second spectral loading operation for the transmission line segment;
execute an AGC cycle to adjust amplifier operating conditions; and
perform the second spectral loading operation on the transmission line segment subsequent to executing the AGC cycle to adjust the amplifier operating conditions.
